(19) United States
(12) Patent Application Publication
(10) Pub. No.: US 2026/0002497 A1
(43) Pub. Date: Jan. 1, 2026

(54) INTERNAL COMBUSTION ENGINE SYSTEM

(71) Applicant: VOLVO TRUCK CORPORATION, GÖTEBORG (SE)

(72) Inventors: Arne Andersson, MÖLNLYCKE (SE); Magnus Christensen, MÖLNDAL (SE)

(21) Appl. No.: 19/243,427

(22) Filed: Jun. 19, 2025

(30) Foreign Application Priority Data
Jun. 26, 2024 (EP) 24184708.6

(51) Int. Cl. F02M 25/022; F02M 21/02; F02M 26/13; F02M 43/00

(52) U.S. Cl. CPC F02M 25/0228; F02M 21/0206; F02M 26/13; F02M 43/00

(57) ABSTRACT

An internal combustion engine (ICE) system operating on a hydrogen-based fuel, comprising: an ICE having at least one cylinder at least partly defining a combustion chamber; a fuel injector arrangement configured to inject a pilot diesel fuel portion and a main hydrogen-based fuel portion into the combustion chamber; an exhaust gas recirculation (EGR) system having an EGR conduit arranged to connect an exhaust manifold and an air intake manifold to permit recirculation of exhaust gas through the at least one cylinder during operation of the ICE; a water condensate extraction system configured to be in fluid communication with the EGR system and further configured to extract water condensate from the exhaust gases circulating in the EGR conduit; and a diesel-water emulsion blender and storage system configured to receive the extracted condensed water and further configured to create a diesel-water emulsion from the extracted condensed water and diesel.

### CROSS REFERENCE TO RELATED APPLICATION

This application claims foreign priority to European Application No. 24184708.6 filed on Jun. 26, 2024, the disclosure and content of which is incorporated by reference herein in its entirety.

### TECHNICAL FIELD

The disclosure relates generally to internal combustion engine systems. In particular aspects, the disclosure relates to internal combustion engine systems for vehicles. The disclosure can be applied to heavy-duty vehicles, such as trucks, buses, and construction equipment, among other vehicle types. Although the disclosure may be described with respect to a particular vehicle, the disclosure is not restricted to any particular vehicle. The disclosure may also be applicable to industrial applications and marine vehicle applications. Further, the internal combustion engine is typically a hydrogen internal combustion engine.

### BACKGROUND

For many years, the demands on internal combustion engines have been steadily increasing. By way of example, reducing exhaust gases, increasing engine efficiency, reducing fuel consumption, and lowering noise level from the engines are some of the criteria that have become more important when designing an internal combustion engine (ICE) system for a heavy-duty vehicle. At least for these reasons, the components of the ICE systems have been continuously developed to meet the various demands from the market. The ICE system may generally need to be developed in view of both prevailing and expected future environmental regulations such as restrictions relating to maximum allowable amount of exhaust gas pollution. These environmental regulations are particularly relevant for heavy-duty vehicles, such as trucks.

One type of ICE system that may have the potential to meet prevailing and future environmental regulations is a hydrogen ICE system in which the combustion of hydrogen with oxygen produces water vapor as the main exhaust product. In such hydrogen ICE system, hydrogen fuel is supplied to the combustion cylinder in gaseous form and subsequently blended with compressed air so as to provide an appropriate mixture of hydrogen and air in the combustion cylinder when performing and completing the combustion reaction.

However, the use of hydrogen as a fuel component in ICE systems may present several challenges. It would be desirable to improve the operation of ICE systems for combustion of hydrogen fuel, such as an ICE system operable on hydrogen gas.

### SUMMARY

According to a first aspect of the disclosure, there is provided an internal combustion engine (ICE) system operating on a hydrogen-based fuel. The ICE system comprises an ICE having at least one cylinder at least partly defining a combustion chamber; a fuel injector arrangement configured to inject a pilot diesel fuel portion and a main hydrogen-based fuel portion into the combustion chamber, an exhaust gas recirculation (EGR) system having an EGR conduit arranged to connect an exhaust manifold and an air intake manifold to permit recirculation of exhaust gas through the at least one cylinder during operation of the ICE; a water condensate extraction system configured to be in fluid communication with the EGR system and further configured to extract water condensate from the exhaust gases circulating in the EGR conduit, wherein the ICE system further comprises a diesel-water emulsion blender and storage system configured to receive the extracted condensed water and further configured to create a diesel-water emulsion from the extracted condensed water and diesel.

The disclosure is at least partly based on the insight that a more stable ignition of hydrogen in a hydrogen ICE system such as an ICE system including a high-pressure direct fuel injection system can be achieved using micro pilot diesel injection operation. In this type of injection operation, a small quantity of diesel fuel, injected first as a pilot, ignites and subsequently ignites the hydrogen. However, challenges, such as a higher relative proportion of diesel in the total fuel mix, may arise at lower engine loads, which can potentially impact efficiency and emissions. Additionally, accurately metering small quantities of diesel may complicate the control of the injection operation and could affect the reliability and efficiency of the engine.

The first aspect of the disclosure may seek to mitigate the above challenges by introducing a system to extract water condensate from the exhaust gas recirculation (EGR) system and utilize this water to create a diesel-water emulsion for the pilot injection. By substituting part of the diesel with water extracted from the exhaust gases, the system reduces diesel volume in the pilot injection. Such substitution may prove advantageous in lower engine load situations, maintaining lower overall diesel usage and enhancing emission control strategies without sacrificing stability or reliability of engine ignition. Furthermore, the proposed ICE system may contribute to targeting CO2 emissions by reducing engine-out nitrogen oxides (NOx) to reduce CO2 production from any selective catalytic reduction (SCR) system connectable to the ICE system. In this context, it has been observed that increasing EGR levels in a hydrogen ICE system may typically provide for reducing engine-out NOx to relatively low levels. Providing an ICE system that can utilize high levels of EGR not only facilitates the reduction of engine-out NOx but also provides higher water concentrations in the exhaust gases from the ICE.

A technical benefit may include enhanced management of fuel and emissions in a hydrogen ICE system. Integrating a water condensate extraction system and using the condensate to form a diesel-water emulsion for pilot injections allows for reducing diesel consumption, particularly under lower load conditions. Introducing water into the combustion process through the emulsion may lower combustion temperatures, thereby reducing the formation of NOx. Additionally, the proposed ICE system may contribute to enhancing fuel metering precision at low fuel quantities by diluting diesel with water, which can be metered more consistently than diesel alone at micro levels. In this manner, it becomes possible to improve both the performance and reliability of the fuel injection system. Thus, the proposed ICE system addresses the dual challenges of reducing both CO2 and NOx emissions, aligning with environmental targets and regulations.

Optionally in some examples, including in at least one preferred example, the water condensate extraction system comprises a cooler for cooling exhaust gases passing through the EGR system. Hereby, water is separated from the cooled exhaust gases. A technical benefit may include improved efficiency in condensing and extracting water from the exhaust gases. Such arrangement may further enhance the recovery of water for use in creating the diesel-water emulsion, which contributes to reducing diesel consumption and emissions.

Optionally in some examples, including in at least one preferred example, the cooler is arranged in fluid communication with a low temperature coolant circuit. A technical benefit may include the use of a low temperature coolant to further enhance the cooling and condensation efficiency. Such setup may contribute to enhanced temperature management.

Optionally in some examples, including in at least one preferred example, the water condensate extraction system is configured to extract water from the cooled exhaust gases through condensation. A technical benefit may include the precise and effective separation of water from exhaust gases.

Optionally in some examples, including in at least one preferred example, the water condensate extraction system comprises a water management system arranged and configured to collect the extracted water from the cooled exhaust gases. A technical benefit may include a more efficient collection of water, which may facilitate the handling and subsequent use of the collected water in the emulsion creation process, ensuring that less extracted water is wasted.

Optionally in some examples, including in at least one preferred example, the water management system is configured to collect water through gravitation. A technical benefit may include reducing the need for additional mechanical components or energy inputs.

Optionally in some examples, including in at least one preferred example, the water management system is configured to transport water in a liquid fluid circuit to the diesel-water emulsion blender and storage system. A technical benefit may include the efficient and controlled transport of water, ensuring a steady and reliable supply to the emulsion system.

Optionally in some examples, including in at least one preferred example, the diesel-water emulsion blender and storage system comprises a diesel-water emulsion storage volume. A technical benefit may include the integrated capability to store the diesel-water emulsion, which ensures that the emulsion is ready for use when needed by the ICE system, thus further enhancing the operational flexibility and efficiency of the fuel system.

Optionally in some examples, including in at least one preferred example, the diesel-water emulsion blender and storage system is configured to supply the created diesel-water emulsion to the fuel injector arrangement. A technical benefit may include the direct and efficient supply of the emulsion to the injector(s), further improving the timing and quantity of fuel delivery.

Optionally in some examples, including in at least one preferred example, the ICE system further comprises a diesel fuel storage system configured to store diesel fuel, the diesel fuel storage system being configured to be in fluid communication with the fuel injector arrangement and the diesel-water emulsion blender and storage system.

Optionally in some examples, including in at least one preferred example, the ICE system comprises a separate storage system for the created diesel-water emulsion, the separate storage system being configured to be in fluid communication with the fuel injector arrangement and the diesel-water emulsion blender and storage system, and wherein the created diesel-water emulsion is routed to the separate storage system and supplied to the fuel injector arrangement upon a demand for a pilot diesel fuel portion injection. A technical benefit may include a dedicated buffer storage of the emulsion, which enhances the management and supply of the fuel component(s).

Optionally in some examples, including in at least one preferred example, the created diesel-water emulsion contains any one of an emulsifier and a lubricity additive. A technical benefit may include the stabilization and enhancement of the properties of the emulsion through additives. Emulsions are typically stabilized by substances known as emulsifiers or surfactants, which reduce the surface tension between the water and diesel and prevent the droplets from coalescing or merging back into separate layers.

Optionally in some examples, including in at least one preferred example, the ICE system is a high-pressure direct injection ICE system. A technical benefit may include the use of high-pressure injection, which may further enhance the mixing and combustion efficiency of the fuel, leading to better engine performance and reduced emissions.

Optionally in some examples, including in at least one preferred example, the fuel injector arrangement may comprise a dual fuel injector configured to selectively inject the pilot diesel fuel portion and the main hydrogen gas fuel portion into the combustion chamber. A technical benefit may include a more precise control over the ignition and fuel injection processes.

Optionally in some examples, including in at least one preferred example, the fuel injector arrangement may be configured to adjust the injection timing of the pilot diesel fuel portion and the main hydrogen-based fuel portion based on engine load and speed. In this manner, a more precis control of the fuel injection may be provided.

According to a second aspect of the disclosure, there is provided a vehicle comprising an internal combustion engine (ICE) system according to the first aspect of the disclosure. Effects and features of this second aspect of the present disclosure are largely analogous to those described above in connection with the first aspect of the disclosure. Examples mentioned in relation to the first aspect of the present disclosure are largely compatible with the second aspect of the disclosure.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary vehicle comprising an internal combustion engine (ICE) system according to an example.

FIG. 2 schematically illustrates an ICE system according to an example.

FIG. 3 schematically illustrates a fuel injector arrangement of an ICE system according to an example.

FIG. 4 schematically illustrates another example of an ICE system according to an example.

### DETAILED DESCRIPTION

The detailed description set forth below provides information and examples of the disclosed technology with sufficient detail to enable those skilled in the art to practice the disclosure.

The present disclosure is at least partly based on the insight that a more stable ignition of hydrogen in a hydrogen internal combustion engine (ICE) system such as an ICE system including a high-pressure direct fuel injection system can be achieved using a micro pilot diesel injection operation. In this type of injection operation, a small quantity of diesel fuel, injected first as a pilot, ignites and subsequently ignites the hydrogen. However, challenges, such as a higher relative proportion of diesel in the total fuel mix, may arise at lower engine loads, which can potentially impact efficiency and emissions. Additionally, accurately metering small quantities of diesel may complicate the control of the injection operation and could affect the reliability and efficiency of the engine.

For these and other reasons, there is still a need for improving the operations of hydrogen ICE systems. Thus, the disclosure seeks to mitigate the above challenges by introducing a system to extract water condensate from the exhaust gas recirculation (EGR) system and utilize this water to create a diesel-water emulsion for the pilot injection. By substituting part of the diesel with water extracted from the exhaust gases, the system reduces diesel volume in the pilot injection. Such substitution may prove advantageous in lower engine load situations, maintaining lower overall diesel usage and enhancing emission control strategies without sacrificing stability or reliability of engine ignition. Furthermore, the proposed ICE system may contribute to targeting CO2 emissions by reducing engine-out nitrogen oxides (NOx) to reduce CO2 production from any selective catalytic reduction (SCR) systems connectable to the ICE system. In this context, it has been observed that increasing EGR levels in a hydrogen ICE system may typically provide for reducing engine-out NOx to relatively low levels. Providing an ICE system that can utilize high levels of EGR not only facilitates the reduction of engine-out NOx but also provides higher water concentrations in the exhaust gases from the ICE.

A technical benefit may include enhanced management of fuel and emissions in a hydrogen ICE system. Integrating a water condensate extraction system and using the condensate to form a diesel-water emulsion for pilot injections allows for reducing diesel consumption, particularly under lower load conditions. Introducing water into the combustion process through the emulsion may lower combustion temperatures, thereby reducing the formation of NOx. Additionally, the proposed ICE system may contribute to enhancing fuel metering precision at low fuel quantities by diluting diesel with water, which can be metered more consistently than diesel alone at micro levels. In this manner, it becomes possible to improve both the performance and reliability of the fuel injection system. Thus, the proposed ICE system addresses the dual challenges of reducing both CO2 and NOx emissions, aligning with environmental targets and regulations.

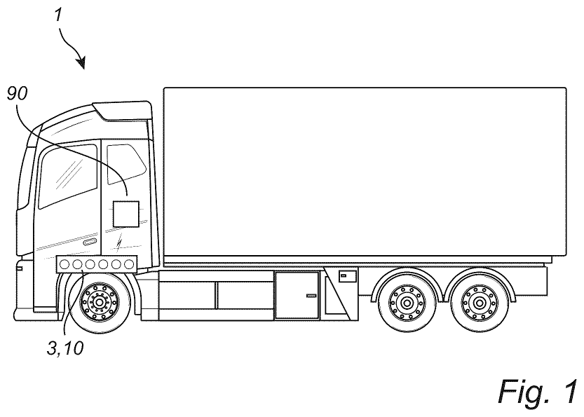

With particular reference to FIG. 1, there is provided a vehicle 1 in the form of a truck. The vehicle 1 comprises an internal combustion engine (ICE) system 2 for powering and driving the vehicle 1. The ICE system 2 in FIG. 1 also comprises an ICE 10. In particular, the ICE 10 is configured to be operable on a hydrogen-based fuel as a main fuel component. Thus, the ICE 10 is intended for combustion of hydrogen gaseous fuel. In particular, the ICE system 2 is a hydrogen piston ICE system, such as a hydrogen otto-cycle ICE system. By way of example, the ICE 10 may advantageously be a four-stroke ICE with a hydrogen gas direct injection system. A hydrogen ICE 10 operable according to a conventional four stroke process performs an intake stroke, a compression stroke, a combustion stroke and an exhaust stroke. Such engine cycle belongs a to common knowledge, and thus not further described herein.

The combustion in a hydrogen ICE system 2 is based on a combustion of air and hydrogen. While the combustion of hydrogen with oxygen may only produce water as its only product in a pure combustion process between hydrogen and oxygen, a hydrogen ICE system 2 based on combustion of air and hydrogen generally produce water, heat and NOx, as is commonly known in the art. In addition, hydrogen can be combusted in an ICE over a wide range of fuel-air mixtures. The hydrogen ICE system may thus be operated to produce low emissions during certain conditions.

It may also be possible to use a mixture of fuels, where the main fuel component is hydrogen. The hydrogen can either be provided in gaseous form or in liquid form. Hence, in some examples, the hydrogen ICE system may be operated based on hydrogen liquid as the main fuel component.

In FIG. 1, the truck is a vehicle 1 with a single propulsion system where traction power is provided by the hydrogen piston ICE system 2. However, the truck may likewise be a hybrid electric vehicle. By way of example, the hybrid electric vehicle comprises a supporting electric propulsion system having at least one high-voltage battery and at least one electric machine, and further the hydrogen ICE system 2.

As depicted in FIG. 1, the ICE system 2 further comprises a control unit 90, herein also denoted as a controller. The controller 90 is typically an integral part of a main electronic control unit for controlling the vehicle 1 and various parts of the vehicle. The controller 90 is arranged in communication with the components of the ICE system 2, in particular the ICE 10. The controller 90 is configured to control the components of the ICE system 2. The controller 90 may likewise be a separate part of the vehicle 1 and communicate with the main electronic control unit for controlling the vehicle and various parts of the vehicle.

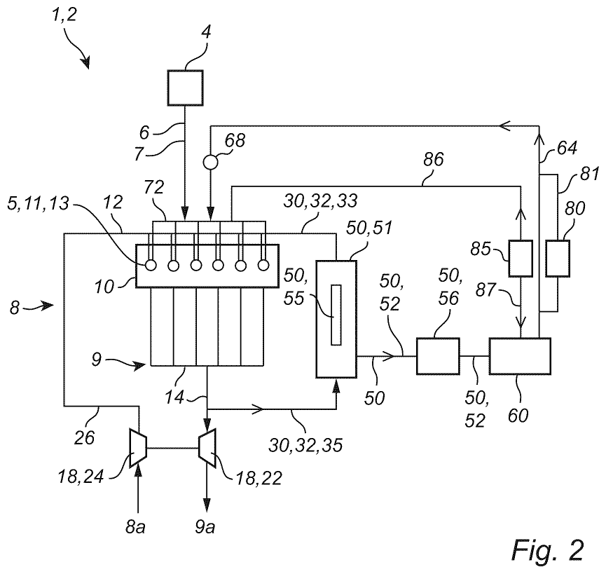

Turning now to FIG. 2, there is depicted an example embodiment of the ICE system 2 for incorporation in the vehicle 1, as described above in relation to FIG. 1. FIG. 2 provides an overview of various parts of the hydrogen gas piston ICE system 2 according to an example. The ICE 10 comprises one or more cylinders 11, one or more corresponding combustion chambers 13 and one or more corresponding pistons 5 reciprocating within the respective cylinders 11. Each one of the combustion chambers 13 is at least partially delimited by a corresponding cylinder 11. Each one of the pistons 5 is arranged and configured to reciprocate inside a corresponding cylinder 11.

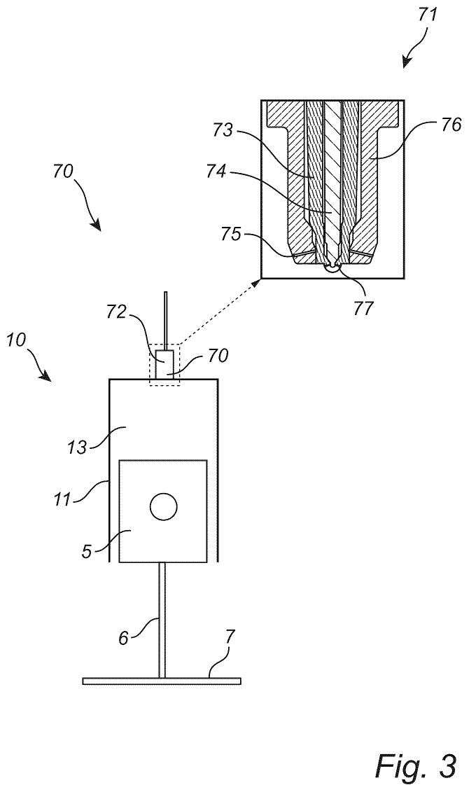

The arrangement of the piston 5 in the cylinder 11 is further illustrated in FIG. 3. The piston 5 is arranged to reciprocate inside the cylinder 11 such that the ICE 10 is operated to combust hydrogen gas fuel, whereby the motion of the piston 5 reciprocating in the cylinder 11 is transmitted to a rotational movement of a crank shaft 7. In FIG. 3, the piston 5 is coupled to the crank shaft 7 via a connecting rod 6. The crank shaft 7 is further coupled to a transmission (not shown) for providing a torque to ground engaging elements. In case of a heavy-duty vehicle, such as a truck, the ground engaging element are wheels; however, the ICE system 2 may also be used for other equipment such as construction equipment, marine applications, etc.

Typically, as may be gleaned from FIG. 2, the ICE 10 comprises a number of combustion chambers 13 for combusting hydrogen gas as a main fuel portion. The hydrogen gas is generally provided to the combustion chambers 13 of the ICE 10 by means of hydrogen fuel supply and storage system and one or more fuel injectors. By way of example, as also illustrated in FIG. 2, the ICE system 2 thus comprises a hydrogen fuel storage system 4 containing the hydrogen fuel in gaseous form. The hydrogen fuel may also be partly arranged in liquid form in the hydrogen fuel storage system 4. The hydrogen fuel storage system 4 comprises one or more tanks for storing the hydrogen fuel. In FIG. 2, hydrogen gas fuel, indicated by reference 7, is supplied to the ICE 10 from the hydrogen fuel storage system 4 via a hydrogen fuel circuit 6 of the ICE system 2. The hydrogen fuel circuit 6 is arranged and configured to contain and transport the hydrogen gas fuel 7, as illustrated in FIG. 2, and may optionally include one or more additional fuel system components such as a fuel pump, fuel filter etc. Such fuel system components are commonly used within fuel systems and thus not further described herein. Typically, the hydrogen fuel storage system 4 includes a pump for pressurizing the hydrogen fuel to an appropriate level, as is commonly known in the art.

The hydrogen fuel 7 gas is eventually injected into the combustion chambers 13 of the ICE 10 through a fuel injector arrangement 72, as illustrated in FIGS. 2 and 3. The fuel injector arrangement 72 is configured to be in fluid communication with each one of the combustion chambers 13 of the ICE 10. Moreover, the fuel injector arrangement 72 is configured to inject the hydrogen gas into the combustion chamber 13 responsive to the operation of the ICE system 2 and/or the vehicle 1. The fuel injector arrangement 72 is here a so-called common rail system comprising a set of fuel injectors, wherein the fuel injector arrangement 72 has one fuel injector for each cylinder 13 of the ICE 10.

The fuel injector arrangement 72 is also configured to inject a pilot diesel fuel portion for ignition purposes. As such, the fuel injector arrangement 72 is configured to inject a pilot diesel fuel portion into the combustion chamber 13. The pilot diesel fuel portion here contains a diesel-water emulsion, as will be further described herein.

To this end, the fuel injector arrangement 72 is configured to inject the pilot diesel fuel portion and the main hydrogen-based fuel portion into the combustion chamber 13. More specifically, the fuel injector arrangement 72 is configured to inject a pilot diesel fuel portion containing the diesel-water emulsion and a main hydrogen-based fuel portion containing hydrogen gas into each one of the combustion chambers 13 of the ICE 10.

The diesel is generally provided to the combustion chambers 13 of the ICE 10 by means of a diesel fuel supply and storage system and via one or more fuel injectors. More specifically, as also illustrated in FIG. 2, the diesel is supplied to the fuel injector arrangement 72 from a diesel fuel storage system 85 via a fluid conduit 86, and then injected into the chambers 13 as a pilot injection by means of the fuel injector arrangement 72. As such, the ICE system 2 here comprises the diesel fuel storage system 85, which is configured to store diesel fuel. The diesel fuel storage system 85 is in fluid communication with the fuel injector arrangement 72 through the fuel conduit 86. The diesel fuel storage system 85 is configured to contain and store diesel. The diesel fuel storage system 85 typically comprises one or more tanks for storing diesel. The fuel conduit 86 is arranged and configured to contain and transport the diesel, as illustrated in FIG. 2, and may optionally include one or more additional fuel system components such as a fuel pump, fuel filter etc. Such fuel system components are commonly used within fuel systems and thus not further described herein. Although not illustrated, the diesel fuel storage system 85 may include a pump for pressurizing the diesel to an appropriate level, as is commonly known in the art.

Moreover, in this example, the ICE system 2 is a high-pressure direct injection ICE system 2. A high pressure direct injection ICE system comprises a high-pressure direct fuel injection system 70. The high-pressure direct fuel injection system 70 operates at much higher pressures than traditional fuel injection systems. A high pressure direct fuel injection system 70 is a fuel delivery technology utilized in heavy-duty vehicles, managing the injection of both diesel and hydrogen gas within the same system. The high pressure direct fuel injection system 70 typically comprises a common rail design that independently controls the injections of diesel in the form of a pilot injection, typically as a micro pilot injection, and hydrogen gas in the form of a main fuel injection portion. In a high-pressure direct fuel injection system 70, fuel is injected directly into the combustion chamber, rather than into the intake manifold. This allows for better control over the combustion process, as the timing and quantity of fuel can be precisely managed.

As such, the fuel injector arrangement 72 is here configured as a high pressure direct fuel injection system, in which the fuel is injected to the combustion chamber(s) with a high pressure. That is, the fuel injector arrangement 72 comprises the high pressure direct fuel injection system 70. The high pressure direct fuel injection system 70 is provided with a common rail system for both hydrogen gas and diesel. Hereby, it becomes possible to further eliminate the need for camshaft-driven pumping work for the dual fuel injectors. The high pressure direct fuel injection system 70 also allows for more efficient and controlled use of dual fuels.

FIG. 3 illustrates one example of a fuel injector arrangement 72 provided in the form of a high pressure direct fuel injection system 70. As shown in FIG. 3, the high pressure direct fuel injection system 70 comprises a dual fuel injector 71. The dual fuel injector 71 can be designed in several different manner. In this example, the dual fuel injector 71 comprises a set of concentric needles, allowing both diesel and hydrogen gas to be delivered through the same injector. Diesel is here used as the pilot injection, serving as the ignition source for the main hydrogen gas injection. The quantity and timing of the diesel pilot injection are adjustable, typically ranging from 4 to 10 milligrams per injection. In such system, engine torque may also be controlled by varying the quantity of hydrogen gas injected.

More specifically, as illustrated in FIG. 3, the fuel injector arrangement 72 comprises the dual fuel injector 71. The dual fuel injector 71 is configured to inject the pilot diesel fuel portion and the main hydrogen gas fuel portion into the combustion chamber 13. In this example, the dual fuel injector 71 is controllable to selectively inject the pilot diesel fuel portion and the main hydrogen gas fuel portion into the combustion chamber 13.

The dual fuel injector 71 here comprises a nozzle 76 having a gas needle 73 with one or more gas spray holes 75 and a pilot needle 74 with at least one pilot spray hole 77. The nozzle 76 may be a conventional dual fuel injector 71 for use in the ICE 10. The nozzle 76 may e.g. be a concentric nozzle with concentric diesel and gas needles. The dual fuel injector 71 is typically configured to allow for independent control of the diesel and gas needles so as to allow for independent control of the diesel and hydrogen gas injections. The diesel pilot can be injected at any time in relation to the hydrogen gas injection. The dual fuel injector is e.g. electrically actuated by an actuator controlled through the controller 90, but other options may also be conceivable.

Although not shown, such dual fuel injector 71 may typically comprise various springs, pilot control chambers, gas and diesel plenums, gas needle control valve, pilot needle control valve, corresponding valve seats, bodies and barrels. Such features and components are all commonly known components of dual fuel injectors, and thus not further described herein.

To this end, FIGS. 2 and 3 schematically illustrates one example of fuel injector arrangement 72 provided in the form of a high pressure direct fuel injection system 70. The high pressure direct fuel injection system 70 comprises a fuel injector arrangement 72. The fuel injector arrangement 72 is configured to be in fluid communication with the combustion chamber 13 of the ICE 10. Moreover, the fuel injector arrangement 72 is configured to inject the pilot diesel fuel portion for ignition purposes and the main hydrogen-based fuel portion into the combustion chamber 13. Typically, the fuel injector arrangement 72 comprises a set of dual fuel injectors 71. As such, each cylinder 11 comprises a corresponding dual fuel injector 72. Each one of the dual fuel injectors 71 is configured to selectively inject the pilot diesel fuel portion and the main hydrogen gas fuel portion into corresponding combustion chambers 13 of the ICE 10.

As mentioned above, the fuel injector arrangement 72 is e.g. a fuel common rail system. Such fuel injector arrangement 72 is configured to supply diesel and hydrogen gas through a common rail conduit in cooperation with the set of dual fuel injectors 71. Thus, the fuel injector arrangement 72 is a diesel and hydrogen gas fuel rail system having a plurality of fuel injectors 71 configured to control the supply of diesel and hydrogen gas fuel to the cylinders 11 of the ICE 10. In particular, each one of the dual fuel injectors 71 is controllable to provide a diesel pilot injection and a hydrogen gas main injection.

It should be noted that the dual fuel injectors 71 are typically integral parts of the fuel injector arrangement 72. The fuel injector arrangement 72 is in fluid communication with the hydrogen gas fuel conduit 6 and the fuel conduit 86 from the diesel fuel storage system 85. Moreover, at least parts of the fuel injector arrangement 72, such as parts of the dual fuel injectors 72, are arranged in the combustion chamber(s) 13 of the cylinders 11.

Through the use of the dual fuel injectors 71, the fuel injector arrangement is also configured to adjust the injection timing of the pilot diesel fuel portion and the main hydrogen-based fuel portion based on engine load and speed. Data indicative of the engine load and engine speed can be provided to the controller 90, which then controls the dual fuel injectors 71 in response to the engine load and engine speed. In this manner, a more precise control of the fuel injection may be provided.

The ICE system 2 is here also a diffusion combustion ICE system. In such ICE system, the fuel combustion occurs through a diffusion combustion process, similar to that of a diesel engine. Such system and method may avoid the challenges associated with pre-mix combustion, such as engine knock, while maintaining engine torque and efficiency.

The ICE system 2 here also comprises an air intake system 8 and an exhaust gas system 9, as depicted in FIG. 2. The air intake system 8 comprises an air intake manifold 12. The air intake system 8 defines an air inlet circuit and comprises an air inlet 8a for receiving fresh air from the outside, as illustrated in FIG. 2. The air intake manifold 12 is thus an integral part of the air intake system 8 and configured to form the air inlet circuit. The air intake manifold 12 may comprise a multiple number of inlet channels having at least one inlet valve for controlling a flow of inlet air to the combustion chambers 13 of the cylinders 11. By way of example, the air intake manifold 12 forms one or more intake guides arranged to guide air to the cylinders 11 of the ICE 10. The air intake manifold 12 is an integral part of the ICE system 2.

The air intake system 8 may also comprise a charge-air-cooler, CAC (not illustrated). The CAC is normally provided in the form of a conventional air to air cooled arrangement in the vehicle 1, but it can also be a liquid coolant cooled arrangement solution. The CAC is arranged to cool supercharged combustion air blown into the ICE 3 for enhancing engine performance.

The exhaust gas system 9 comprises an exhaust manifold 14, as depicted in FIG. 2. The exhaust gas system 9 defines an exhaust gas conduit at least partly provided by the exhaust manifold 14, and has a corresponding exhaust gas outlet 9a, as illustrated in FIG. 2. The exhaust manifold 14 comprises at least one, but typically a multiple number of exhaust channels having a least one exhaust valve (not shown) for controlling discharge of exhaust gases produced from the fuel combustion process taking place in the combustion chambers 13 within the cylinder(s) 11. The ICE 10 typically comprises one or more exhaust ports with corresponding exhaust valves. The exhaust manifold 14 is configured to be in fluid communication with the exhaust port(s) of the ICE 10. The exhaust gas system 9 is thus configured and arranged to guide gases from the cylinders 11 to the outlet 9a via the exhaust manifold 14 forming at least parts of the exhaust gas conduit. The air intake system 8 and the exhaust gas system 9 are of conventional types and thus not further described herein.

Turning again to FIG. 2, the ICE system 2 optionally comprises a turbocharger 18. The turbocharger 18 is arranged to receive exhaust gases from the ICE 3. The turbocharger 18 receives exhaust gases from the ICE 10 via the exhaust gas system 9. The turbocharger 18 comprises an exhaust gas inlet and an exhaust gas outlet. The exhaust gas inlet is in fluid communication with the exhaust gas ports of the ICE 10.

As depicted in FIG. 2, the turbocharger 18 comprises a turbine 22. The turbine 22 is powered by exhaust gas from the ICE 10. Moreover, as illustrated in e.g. FIG. 2, the turbocharger 18 comprises a compressor 24 for compressing intake air and feeding the intake air to the ICE 10. The compressor 24 is thus in fluid communication with the ICE air intake system 8. The compressor 24 is also in fluid communication with the air inlet 8a, as illustrated in FIG. 2. The compressor 24 is thus an intake air compressor arranged in the air intake system 8 and the turbine 22 is an exhaust gas turbine arranged in the exhaust gas system 9. By way of example, the compressor 24 of the turbocharger is a centrifugal compressor. The intake air centrifugal compressor 24 is operatively connected via a shaft to the exhaust gas turbine 22, as shown FIG. 2.

Typically, although not illustrated, ICE system 2 further comprises an aftertreatment system. The aftertreatment system is here a so-called exhaust gas aftertreatment system, EATS. The EATS is disposed in the exhaust gas stream downstream the ICE 10. As such, the EATS is arranged in the exhaust gas circuit downstream the ICE 10. The EATS is typically also arranged downstream the exhaust gas turbine 22. The ICE system may further include a wastegate (not illustrated) arranged to allow exhaust gas to bypass the exhaust gas turbine 22. The EATS may generally contain catalytic converters and similar components for treating the exhaust gas. For example, the EATS comprises a NOx reduction device. The NOx reduction device is a common component of an EATS system, and thus not further described herein.

The ICE system 2 further comprises an exhaust gas recirculation (EGR) system 30, as illustrated in FIG. 2. The EGR system 30 comprises an EGR conduit 32. The EGR conduit 32 is arranged to connect the exhaust manifold 14 and the air intake manifold 12 to permit recirculation of exhaust gas through the cylinder(s) 11 during operation of the ICE 10. As such, the EGR system 30 is in fluid communication with the exhaust port(s) of the ICE 10 and in fluid communication with the intake port(s) of the ICE 10. EGR systems are common systems used in vehicles such as heavy-duty vehicles.

In this context, it should also be noted that the produced exhaust gases typically contain water as a combustion-product as the ICE is operable on hydrogen gas. It has been observed that the water in the exhaust gases may at least partly be recovered and subsequently used in the combustion process in the cylinders rather than injecting fresh water from a separate and heavy water tank. Thus, the ICE system 2 here comprises a water condensate extraction system 50. The water condensate extraction system 50 is an integral part of the EGR system 30, as illustrated in FIG. 2. As such, the EGR system 30 comprises the water condensate extraction system 50, or at least parts of the water condensate extraction system 50. The water condensate extraction system 50 is here in fluid communication with a diesel-water emulsion blender and storage system 60. The water condensate extraction system 50 and the diesel-water emulsion blender and storage system 60 will now be further described hereinafter in relation to FIG. 2.

The water condensate extraction system 50 is configured to be in fluid communication with the EGR system 30, i.e. in fluid communication with the exhaust gases circulating in the EGR system 30. The water condensate extraction system 50 is further configured to extract water condensate from the exhaust gases circulating in the EGR conduit 32. By way of example, the EGR system 30 comprises the water condensate extraction system 50. The water condensate extraction system 50 is arranged inside the EGR system 30, as shown in FIG. 2. The water condensate extraction system 50 is disposed in the EGR system 30 and in fluid communication with a first part 35 of the EGR conduit 32 and a second part 33 of the EGR conduit 32, as shown in FIG. 2. The first part 35 is fluidly connected to the exhaust manifold 14 and the second part 33 is fluidly connected to the intake manifold 12.

In this manner, the water condensate extraction system 50 is in fluid communication with the exhaust gases directed from the exhaust manifold 14 to the intake manifold 12. As such, the water condensate extraction system 50 is arranged and configured to extract water condensate from the exhaust gases circulating in the EGR conduit 32.

The water condensate extraction system 50 is also in fluid communication with the diesel-water emulsion blender and storage system 60, as illustrated in FIG. 2.

In FIG. 2, the water condensate extraction system 50 comprises a cooler 51 for cooling exhaust gases passing through the EGR system 30. Hereby, water is extracted from the cooled exhaust gases. More specifically, the cooler 51 is configured to decrease the temperature of the exhaust gases so that water vapor is condensed into liquid water. For examples, the cooler 51 is a heat exchanger configured to cool the exhaust gases down to a temperature below the dew point of water, causing condensation. Hence, the heat exchanger provides a condensate function, in that water condensate is extracted from the cooled exhaust gases. The cooler 51 may be designed to maximize the contact area between the exhaust gases and the cooling surfaces, ensuring efficient condensation. As such, the cooler 51 is a heat exchanger configured to works as a condenser for cooling down exhaust gases to the point where water vapor condenses into liquid water. The cooler 51 can either be an air-cooled condenser or a water-cooled condenser.

The cooler 51 is typically cooled by a coolant fluid circuit of the ICE (not shown). Hence, the cooler 51 is typically in fluid communication with the common coolant circuit of the ICE system. The cooler 51 may in addition, or alternatively, be cooled by a separate coolant circuit.

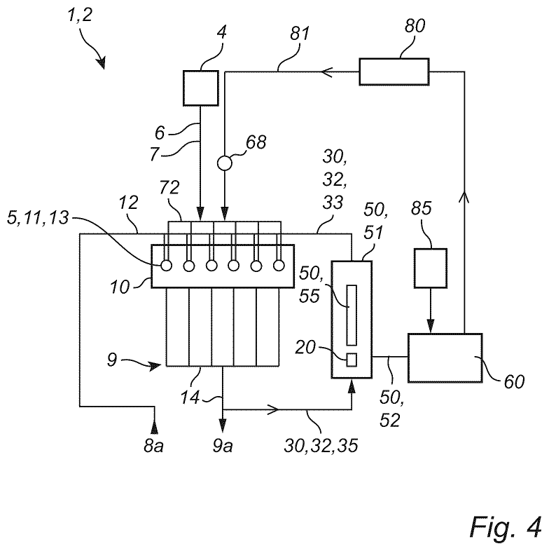

FIG. 4 illustrates an example in which the cooler 51 is an air-cooled condenser, and where the cooler 51 is further cooled through a low temperature coolant circuit 20. Hence, as shown in FIG. 4, the cooler 51 is arranged in fluid communication with a low temperature coolant circuit 20.

The water condensate extraction system 50 can thus be provided in several different manners. The purpose of this system is to extract and manage water condensate from the cooled exhaust gases. To this end, the water condensate extraction system 50 is configured to extract water from the cooled exhaust gases through condensation.

Typically, the surface temperature of the cooler 51 should be regulated to a temperature of about 60 degrees C. to allow for extraction of water droplets from the exhaust gases.

Merely as an example, a condensation temperature of 60° C. (at atmospheric pressure) may provide water separation of about 20% (volume percentage) water from 4 gram NOx.

In addition, the ICE system 2 here comprises a water management system 55. More specifically, the water condensate extraction system 50 comprises the water management system 55. The water management system 55 is configured to collect and manage the water that has been extracted from the exhaust gases by means of the cooler 51. As such, the water management system 55 is arranged and configured to collect the extracted water from the cooled exhaust gases.

By way of example, the water management system 55 is configured to collect water through gravitation. By configuring the water management system 55 to collect water through gravitation, the water management system 55 utilizes gravity to collect and transport the condensed water.

The water management system 55 may typically include one or more reservoirs, pipelines to store and transport the water, and possibly a pump or other mechanism to direct and the collected water to the diesel-water emulsion blender and storage system 60, as illustrated in FIG. 2.

By way of example, the water management system 55 is configured to transport water in a liquid fluid conduit 52 from the water condensate extraction system 50 to the diesel-water emulsion blender and storage system 60.

For example, as illustrated in FIG. 2, the water management system 55 comprises a water storage tank 56 for receiving and storing the extracted water from the cooler (condenser) 51. The water storage tank 56 is disposed in the liquid fluid conduit 52. The water storage tank 56 is disposed in the liquid fluid conduit 52 between the water condensate extraction system 50 and the diesel-water emulsion blender and storage system 60.

As schematically shown in FIG. 2, the water management system 55 is configured to collect water through gravitation by positioning the water storage tank 56 at a lower point relative to the condensation site (cooler 51/condenser), allowing water to flow naturally due to gravity. Such design may reduce the need for additional energy-consuming components like pumps.

To this end, the water condensate extraction system 50 provides for exhaust gas cooling and water extraction from the cooled exhaust gases according to the following operations. Initially, the exhaust gases from the ICE 10 are directed into the EGR system 30, where they pass through the cooler 51, typically provided in the form of a heat exchanger with a condensation functionality. As the gases cool, water vapor within the gases condense into liquid form. The liquid water formed from the condensation process is captured by the water condensate extraction system 50. This system ensures that the water is effectively separated from the remaining exhaust gases. Once separated, the water is directed into the water management system 55. Utilizing gravity, the water flows down into the water storage tank 56. Such passive collection method is energy-efficient, reducing the need for mechanical pumps and other devices.

The water management system 55 is typically arranged below the cooler 51, as seen in a vertical orientation of the ICE system 20. Thus, in one example, the water management system 55 is arranged vertically below the cooler 51 in the vehicle 1.

The collected water, or parts of the collected water, is then redirected to the diesel-water emulsion blender and storage system 60, as shown in FIG. 2. The water management system 55 is arranged to transport water to the diesel-water emulsion blender and storage system 60. By way of example, the water management system 55 is configured to transport water in a liquid fluid circuit 52 to the diesel-water emulsion blender and storage system 60. It should be noted that remaining collected water, or excessive collected water can be handled in various ways, depending on the design of the system. Excessive water can be stored for later use, redirected for other cooling processes, or disposed of in an environmentally friendly manner.

As mentioned above, the ICE system 2 comprises the diesel-water emulsion blender and storage system 60, which is configured to create and store a diesel-water emulsion from the extracted condensed water and diesel. The diesel-water emulsion blender and storage system 60 is in fluid communication with the EGR system 30. The diesel-water emulsion blender and storage system 60 is also in fluid communication with the water condensate extraction system 50. The diesel-water emulsion blender and storage system 60 can be an integral part of the EGR system 30. Alternatively, the diesel-water emulsion blender and storage system 60 is an integral part of the ICE system 2 that is arranged in fluid communication with the EGR system 30.

The diesel-water emulsion blender and storage system 60 is configured to receive the extracted condensed water from the water condensate extraction system 50 and further configured to create a diesel-water emulsion from the extracted condensed water and diesel. More specifically, as illustrated in FIG. 2, the diesel-water emulsion blender and storage system 60 is arranged in fluid communication with the water condensate extraction system 50 via the water management system 55.

As illustrated in FIG. 2, the diesel-water emulsion blender and storage system 60 is also in fluid communication with the diesel fuel storage system 85. The diesel-water emulsion blender and storage system 60 is in fluid communication with the diesel fuel storage system 85 via a fuel conduit 87. As such, the diesel-water emulsion blender and storage system 60 receives extracted condensed water from the exhaust gases and diesel from the diesel fuel storage system 85.

In one example, the water-diesel emulsion blender and storage system 60 is configured to blend the received extracted water directly with the received diesel to create a diesel-water emulsion. The diesel-water emulsion is thus created within the system 60, where diesel and water, along with any optional additives, are mixed together.

The created diesel-water emulsion typically contains an additive, such as an emulsifier and/or a lubricity additive. The diesel-water emulsion is typically stabilized by substances known as emulsifiers or surfactants, which reduce the surface tension between the water and diesel and prevent the droplets from coalescing or merging back into separate layers. The addition of emulsifiers ensures that the emulsion remains stable during storage and use, preventing the diesel and water from separating. Lubricity additives are used to ensure the emulsion maintains the necessary lubrication properties for engine components.

The diesel and extracted water are mixed together in a predetermined ratio, commonly ranging from 0 to 50% water by volume, preferably between 5% to 50% water by volume, still preferably between 10% to 25% water by volume. The ration typically depends on the desired properties of the emulsion and the requirements of the ICE 10 and/or application. The mixing process may typically need to be relatively vigorous to create small water droplets and disperse them evenly throughout the diesel. After initial mixing, the mixture is typically passed through a homogenizer, which further breaks down the water droplets into even smaller sizes, typically in the micron range. Such operation may allow for creating a stable emulsion, as smaller droplets have a lower tendency to coalesce and separate from the diesel. As mentioned herein, the emulsion typically contains a selected emulsifier, which is added during or after the mixing process to help stabilize the emulsion. The emulsifiers adsorb around the water droplets, creating a protective barrier that prevents the droplets from coming together and separating from the diesel.

In this context, it can be observed that using a diesel-water emulsion as a pilot fuel instead of pure diesel allows for CO2 reductions for a given and stable pilot quantity. For example, if the pilot quantity of the diesel-water emulsion consists of 50% diesel and 50% extracted water, such as 3 mg of diesel and 3 mg of water, totaling 6 mg—the CO2 reduction would effectively be calculated at the level of 3 mg.

The diesel-water emulsion blender and storage system 60 typically comprises a diesel-water emulsion storage volume. The diesel-water emulsion blender and storage system 60 is configured to blend and temporarily store the diesel-water emulsion in the storage volume. The diesel-water emulsion blender and storage system blends the diesel, water, and emulsifiers to create a homogeneous emulsion. The diesel-water emulsion blender and storage system 60 thus blends diesel fuel with the extracted water and emulsifiers to form a stable emulsion.

The diesel-water emulsion blender and storage system 60 is configured to supply the created diesel-water emulsion to the fuel injector arrangement 72. In this manner, the created diesel-water emulsion is then directed to the ICE 10 for use as a fuel component in the pilot diesel injection portion.

Typically, the created diesel-water emulsion may be sprayed into the cylinder 11 at high pressure, typically about 150-800 bar, but more preferably at a high pressure of about 150-500 bar. Therefore, since the diesel-water emulsion may have a lower pressure in the diesel-water emulsion blender and storage system 60, which typically corresponds to atmospheric pressure, the fuel injection pressure may, in some examples, need to be increased using a high-pressure pump 68. The high-pressure pump 68 is typically operable to increase the pressure from atmospheric pressure to about 150-500 bar. The high-pressure pump 68 is thus configured to increase the pressure of the diesel-water emulsion that is to be fed to the fuel injector arrangement 72. In another example, the high-pressure pump 68 is operable to increase the fuel pressure from about 150-300 bar to 700 bar, which may be particularly useful for high-pressure direct injection ICE systems. In other ICE systems, the fuel injection pressure may be between 150-300 bar. A fuel injection pressure of about 500 bar could also be conceivable. It should further be noted that the fuel injection pressure is typically varied in response to engine load, where at lower loads (typically referring to engine torque), a fuel injection pressure in the lower region, 150-250 bar, may be required and at higher loads, higher fuel injection pressures, typically above 300 bar, may be needed. In some examples, the fuel injection pressure at high engine loads may be about 300-500 bar.

The created diesel-water emulsion can be supplied to the fuel injector arrangement 72 in several different ways. FIG. 2 illustrates a number of options for storing and supplying the created diesel-water emulsion to the ICE 10.

In one example, as shown in FIG. 2, the diesel-water emulsion blender and storage system 60 is configured to directly supply the created diesel-water emulsion to the fuel injector arrangement 72. The created diesel-water emulsion is here supplied to the fuel injector arrangement 72 via a diesel-water emulsion conduit 64.

As such, the pilot diesel injection portion contains the diesel-water emulsion. The diesel-water emulsion is here pressurized by the high-pressure pump 68, which is disposed in the diesel-water emulsion conduit 64. The high-pressure pump 68 may be a conventional fluid pump, as commonly used in fuel systems.

Additionally, or alternatively, the created diesel-water emulsion is routed to a separate storage system 80 for the created diesel-water emulsion. As such, the ICE system 2 comprises the separate storage system 80 for the created diesel-water emulsion. The separate storage system 80 is configured to be in fluid communication with the fuel injector arrangement 72 and the diesel-water emulsion blender and storage system 60. The separate storage system 80 is in fluid communication with the fuel injector arrangement 72 via a corresponding diesel-water emulsion conduit 81, as shown in FIG. 2. The diesel-water emulsion conduit 81 here intersects with the diesel-water emulsion conduit 64. Moreover, the created diesel-water emulsion is routed to the separate storage system 80 and supplied to the fuel injector arrangement 72 on demand. The demand for supplying created diesel-water emulsion as a fuel component in the diesel pilot injection is controlled by the controller 90. Hence, the created diesel-water emulsion is routed to the separate storage system 80 and supplied to the fuel injector arrangement 72 upon a demand for the diesel pilot injection and in response to a fuel supply command from the controller 90. Typically, although not illustrated, the separate storage system 80 is connected to the high-pressure pump 68 to ensure that the created diesel-water emulsion is directed to the fuel injector arrangement 72 in an appropriate manner with an appropriate pressure.

Additionally, diesel may also be supplied to the fuel injector arrangement 72 from the diesel fuel storage system 85 upon a demand for a diesel pilot injection, wherein the diesel pilot injection contains diesel from the diesel fuel storage system 85 and created diesel-water emulsion. As shown in FIG. 2, the diesel fuel storage system 85 is configured to store diesel fuel, as mentioned above, and further configured to be in fluid communication with the fuel injector arrangement 72 and the diesel-water emulsion blender and storage system 60.

The created diesel-water emulsion is typically supplied to the fuel injector arrangement 72 upon a demand for the diesel pilot injection. The demand for diesel pilot injection is controlled by the controller 90. Hence, the created diesel-water emulsion is supplied to the fuel injector arrangement 72 upon a demand for the diesel pilot injection and in response to a fuel supply command from the controller 90.

In one example, the ICE system 2 is configured to use either pure diesel from the diesel fuel storage system 85 or diesel-water emulsion from the separate storage system 80 acting as a buffer tank.

It should be noted that the ICE system 2 may only include one of the above options of supplying the created diesel-water emulsion to the fuel injector arrangement 72. Hence, the created diesel-water emulsion can be supplied to the fuel injector arrangement 72 in a direct manner via the conduit 64 and/or through the separate storage system 80.

FIG. 4 shows an example of an ICE system 2 comprising the separate storage system 80. In this example, the created diesel-water emulsion is supplied through the separate storage system 80. The ICE system 2 of FIG. 4 may comprise any one of the features and components of the example in FIG. 2.

As mentioned herein, the created diesel-water emulsion is to be used as the pilot diesel fuel portion, or at least as a fuel component in the pilot diesel fuel portion. The pilot diesel fuel portion is injected into the cylinder(s) 11 for igniting the existing gases within the combustion chamber(s) 13. The pilot diesel fuel portion injection is typically a micro pilot diesel fuel portion injection. In this context, the term “micro” refers to about 0.5 to 2% in volume of the total fuel injection portion.

By using extracted water to create the diesel water emulsion for the pilot diesel fuel portion injection, it becomes possible to decrease the diesel amount in the pilot diesel fuel portion injection as well as feed water into the area where the combustion takes place which will reduce NOx production to some extent.

In one example, the water condensate extraction system 50 comprises the cooler 51 for cooling exhaust gases, wherein the condenser is a separate component integrated with the cooler 51 so as to condensate exhaust gases. The cooler 51 may be a conventional heat exchanger, such as a flat plate heat exchanger or a tub heat exchanger. The condenser may e.g. be a conventional heat exchanger, such as a surface condenser, e.g. a water-cooled shell and tube heat exchanger installed to condense exhaust gases.

As mentioned above in FIG. 4, the ICE system 2 comprises the low temperature coolant circuit 20. The low temperature coolant circuit 20 may be arranged in fluid communication with the conventional front radiator of the vehicle 1. The low temperature coolant circuit 20 thus contains a coolant. The coolant circulating in the low temperature coolant circuit 20 is e.g. a liquid coolant, e.g. water. The low temperature coolant circuit 20 is arranged in fluid communication with the cooler 51. The low temperature coolant circuit 20 may comprise its own coolant fluid pump for directing the coolant through the circuit. The coolant pump may be of a conventional pump.

The control unit 90 may include a microprocessor, microcontroller, programmable digital signal processor or another programmable device. Thus, the controller typically comprises electronic circuits and connections as well as processing circuitry such that the control unit can communicate with different parts of the ICE system such as the ICE. The control unit may comprise modules in either hardware or software, or partially in hardware or software and communicate using known transmission buses such as CAN-bus and/or wireless communication capabilities. The processing circuitry may be a general purpose processor or a specific processor. The control unit typically comprises a non-transitory memory for storing computer program code and data upon. Thus, the control unit may be embodied by many different constructions. The control unit 90 may include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

Moreover, the present disclosure may be exemplified by any one of the below examples.

Example 1: An internal combustion engine ICE system 2 operating on a hydrogen-based fuel, comprising: an ICE 10 having at least one cylinder 11 at least partly defining a combustion chamber 13; a fuel injector arrangement 72 configured to inject a pilot diesel fuel portion and a main hydrogen-based fuel portion into the combustion chamber; an exhaust gas recirculation EGR system 30 having an EGR conduit 32 configured to connect an exhaust manifold 14 and an air intake manifold 12 to permit recirculation of exhaust gas through the at least one cylinder during operation of the ICE; a water condensate extraction system 50 configured to be in fluid communication with the EGR system, and further configured to extract water condensate from the exhaust gases circulating in the EGR conduit; and a diesel-water emulsion blender and storage system 60 configured to receive the extracted condensed water and further configured to create a diesel-water emulsion from the extracted condensed water and diesel.

Example 2. The ICE system of example 1, wherein the water condensate extraction system comprises a cooler 51 for cooling exhaust gases passing through the EGR system.

Example 3. The ICE system of example 2, wherein the cooler is arranged in fluid communication with a low-temperature coolant circuit 20.

Example 4. The ICE system of any previous examples, wherein the water condensate extraction system is configured to extract water from the cooled exhaust gases through condensation.

Example 5. The ICE system of any previous examples, wherein the water condensate extraction system comprises a water management system 55 arranged and configured to collect the extracted water from the cooled exhaust gases.

Example 6. The ICE system of example 5, wherein the water management system is configured to collect water through gravitation.

Example 7. The ICE system of any previous examples 5 to 6, wherein the water management system is configured to transport water in a liquid fluid circuit 52 to the diesel-water emulsion blender and storage system.

Example 8. The ICE system of any previous examples, wherein the diesel-water emulsion blender and storage system is configured to supply the created diesel-water emulsion to the fuel injector arrangement.

Example 9. The ICE system of any previous examples, further comprising a diesel fuel storage system 85 configured to store diesel, the diesel fuel storage system being configured to be in fluid communication with the fuel injector arrangement and the diesel-water emulsion blender and storage system.

Example 10. The ICE system of any previous examples, further comprising a separate storage system 80 for the created diesel-water emulsion, the separate storage system being configured to be in fluid communication with the fuel injector arrangement and the diesel-water emulsion blender and storage system, and wherein the created diesel-water emulsion is routed to the separate storage system and supplied to the fuel injector arrangement upon a demand for a pilot diesel fuel portion injection.

Example 11. The ICE system of any previous examples, wherein the created diesel-water emulsion contains any one of an emulsifier and a lubricity additive.

Example 12. The ICE system of any previous examples, wherein the ICE system is a high pressure direct injection ICE system.

Example 13. The ICE system of any previous examples, wherein the fuel injector arrangement comprises a dual fuel injector 71 configured to selectively inject the pilot diesel fuel portion and the main hydrogen gas fuel portion into the combustion chamber.

Example 14. The ICE system of any of previous examples, wherein the fuel injector arrangement is configured to adjust the injection timing of the pilot diesel fuel portion and the main hydrogen-based fuel portion based on engine load and speed.

Example 15. A vehicle 1 comprising an internal combustion engine system 2 according to any one of the examples 1 to 14.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. An internal combustion engine (ICE) system operating on a hydrogen-based fuel, comprising:
an ICE having at least one cylinder at least partly defining a combustion chamber;
a fuel injector arrangement configured to inject a pilot diesel fuel portion and a main hydrogen-based fuel portion into the combustion chamber;
an exhaust gas recirculation (EGR) system having an EGR conduit configured to connect an exhaust manifold and an air intake manifold to permit recirculation of exhaust gas through the at least one cylinder during operation of the ICE;
a water condensate extraction system configured to be in fluid communication with the EGR system, and further configured to extract water condensate from the exhaust gases circulating in the EGR conduit; and
a diesel-water emulsion blender and storage system configured to receive the extracted condensed water and further configured to create a diesel-water emulsion from the extracted condensed water and diesel.

2. The ICE system of claim 1, wherein the water condensate extraction system comprises a cooler for cooling exhaust gases passing through the EGR system.

3. The ICE system of claim 2, wherein the cooler is arranged in fluid communication with a low-temperature coolant circuit.

4. The ICE system of claim 2, wherein the water condensate extraction system is configured to extract water from the cooled exhaust gases through condensation.

5. The ICE system of claim 1, wherein the water condensate extraction system comprises a water management system arranged and configured to collect the extracted water from the cooled exhaust gases.

6. The ICE system of claim 5, wherein the water management system is configured to collect water through gravitation.

7. The ICE system of claim 5, wherein the water management system is configured to transport water in a liquid fluid circuit to the diesel-water emulsion blender and storage system.

8. The ICE system of claim 1, wherein the diesel-water emulsion blender and storage system is configured to supply the created diesel-water emulsion to the fuel injector arrangement.

9. The ICE system of claim 1, further comprising a diesel fuel storage system configured to store diesel, the diesel fuel storage system being configured to be in fluid communication with the fuel injector arrangement and the diesel-water emulsion blender and storage system.

10. The ICE system of claim 1, further comprising a separate storage system for the created diesel-water emulsion, the separate storage system being configured to be in fluid communication with the fuel injector arrangement and the diesel-water emulsion blender and storage system, and wherein the created diesel-water emulsion is routed to the separate storage system and supplied to the fuel injector arrangement upon a demand for a pilot diesel fuel portion injection.

11. The ICE system of claim 1, wherein the created diesel-water emulsion contains any one of an emulsifier and a lubricity additive.

12. The ICE system of claim 1, wherein the ICE system is a high pressure direct injection ICE system.

13. The ICE system of claim 1, wherein the fuel injector arrangement comprises a dual fuel injector configured to selectively inject the pilot diesel fuel portion and the main hydrogen gas fuel portion into the combustion chamber.

14. The ICE system of claim 1, wherein the fuel injector arrangement is configured to adjust the injection timing of the pilot diesel fuel portion and the main hydrogen-based fuel portion based on any one of engine load and engine speed.

15. A vehicle comprising an internal combustion engine system according to claim 1.
